(19) United States
(12) Patent Application Publication
(10) Pub. No.: US 2017/0295074 A1
(43) Pub. Date: Oct. 12, 2017

(54) CONTROLLING AN UNKNOWN FLOW INFLOW TO AN SDN CONTROLLER IN A SOFTWARE DEFINED NETWORK (SDN)

(71) Applicant: HEWELETT PACKARD ENTERPRISE DEVELOPMENT LP, Houston, TX (US)

(72) Inventors: Sugesh CHANDRAN, Bangalore (IN); Subin Cyriac MATHEW, Bangalore (IN); Celestian KANIAMPADY SEBASTIAN, Bangalore (IN)

(73) Assignee: HEWELETT PACKARD ENTERPRISE DEVELOPMENT LP, Houston, TX (US)

(21) Appl. No.: 15/507,568

(22) PCT Filed: Apr. 16, 2015
(86) PCT No.: PCT/US2015/026234

§ 371 Date: Feb. 28, 2017

(30) Foreign Application Priority Data
Mar. 2, 2015 (IN) 996/CHE/2015

(51) Int. Cl. H04L 12/26; H04L 12/935

(52) U.S. Cl. CPC H04L 43/026; H04L 49/3009; H04L 49/25

(57) ABSTRACT

Examples disclosed herein relate to controlling an unknown flow inflow to an SDN controller in a software defined network (SDN). In an example, an optimizer may be provided, between a switch and an SDN controller, to intercept an unknown flow from the switch to the SDN controller, in a software defined network. A portion of a data packet from each data packet in a plurality of data packets from the unknown flow may be aggregated at the optimizer. Only the aggregated portion of the data packet from each data packet may be sent, from the optimizer to the SDN controller, in a single package.

### BACKGROUND

A new approach in networking includes a routing architecture in which data and control planes are decoupled. This new split-architecture framework that focuses on splitting of control plane from forwarding and data plane is the basis of software defined networking (SDN). In a software defined network (SDN), the control plane is implemented in an SDN controller and the data plane is implemented in the networking infrastructure (e.g., switches and routers). Data forwarding on a network device is controlled through flow table entries populated by the SDN controller that manages the control plane for that network. A network device that receives packets on its interfaces looks up its flow table to check the actions that need to be taken on a received packet.

### BRIEF DESCRIPTION OF THE DRAWINGS

For a better understanding of the solution, embodiments will now be described, purely by way of example, with reference to the accompanying drawings, in which:

FIG. 1 is a block diagram of an example system for controlling an unknown flow inflow to an SDN controller in a software defined network;

FIG. 2 is a diagram of an example network system for controlling an unknown flow inflow to an SDN controller in a software defined network;

FIG. 3 is a block diagram of an example method for controlling an unknown flow inflow to an SDN controller in a software defined network; and

FIG. 4 is a block diagram of an example system for controlling an unknown flow inflow to an SDN controller in a software defined network.

### DETAILED DESCRIPTION

Software defined networking (SDN) is an approach to networking in which control is decoupled from networking equipment and given to a device called a controller (or SDN controller). The controller is aware of all the devices and their points of interconnection in a SDN network and may perform various functions such as routing, policy implementation, receiving unknown flow packets, path resolution, flow programming, etc. Each new or missed flow through the network is routed via the controller that decides the network path for a flow and adds an entry for that flow in a flow table, in each of the network devices along the path. A SDN enabled device consults a flow table(s) for forwarding packets in the data plane. Each forwarding rule (flow entry) includes an action that dictates how traffic that matches the rule is to be handled. Thus, in a software defined network, a network administrator may shape traffic from a centralized control console (i.e. an SDN controller) instead of directly interacting with individual switches.

There may be a scenario where the number of unknown flows in a software defined network may increase. For instance, in case there's a sudden spike of new flows in a part of the network, or if there's a DoS (Denial of Service) attack on the network. In such events, the load on a SDN controller may increase tremendously since every unknown packet received by a network device on the network may be forwarded to the controller. Thus, the controller may get flooded with unwanted packets. In fact, the load on a controller may become so heavy that a livelock situation may arise wherein the controller may end up servicing only packet interrupts and nothing else. Needless to say, this is not desirable from the perspective of a network user.

To address such issues, the present disclosure describes various examples for controlling an unknown flow inflow to an SDN controller in a software defined network (SDN). In an example, an optimizer may be provided, between a switch and an SDN controller, to intercept an unknown flow from the switch to the SDN controller in a software defined network. The optimizer may aggregate a portion of a data packet from each data packet in a plurality of data packets from the unknown flow, wherein selection of the portion of the data packet is based upon a predefined criterion between the optimizer and the controller. Upon aggregation, the optimizer may send only the aggregated portion of the data packet from each data packet to the SDN controller, and retain the original data packets at the optimizer. The proposed solution proposes placing one or more intelligent controller channel optimizers in the paths between a central SDN controller and various network devices to efficiently regulate the unknown flow inflow to the controller.

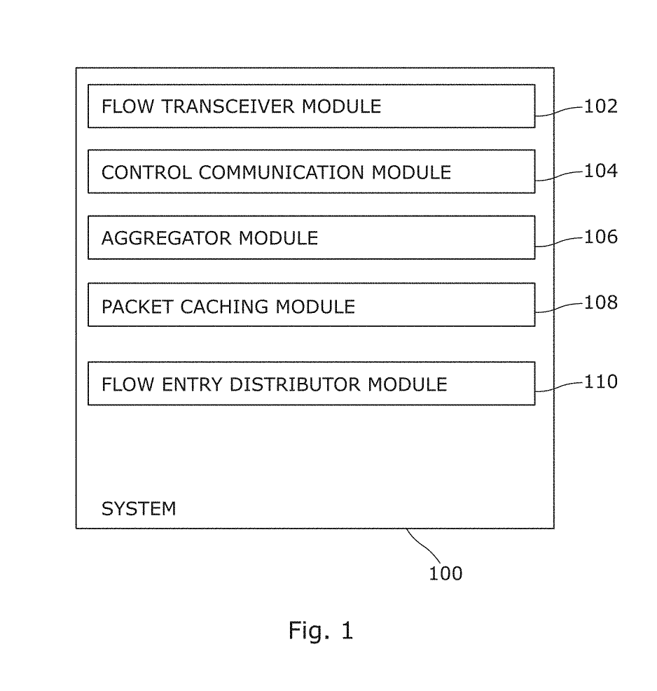

FIG. 1 is a block diagram of an example system for controlling an unknown flow inflow to an SDN controller in a software defined network. In an example, system 100 may represent any type of computing system capable of reading machine-executable instructions. Examples of computing device 100 may include, without limitation, a server, a desktop computer, a notebook computer, a tablet computer, a thin client, a mobile device, a personal digital assistant (PDA), a phablet, and the like.

In another example, system 100 may be a network device such as, but not limited to, a network switch, a network router, a virtual switch, and a virtual router. In a further example, system 100 may be an SDN enabled device or an Open-Flow enabled device. In a yet another example, system 100 may be a computer application (machine-executable instructions).

In an example, system 100 may be called as an “optimizer”. In an example, an optimizer 100 may be placed between an SDN controller and a network device (for example, a switch) in a software defined network. Among other tasks, optimizer 100 may intercept an unknown flow from the network device to the SDN controller. In another instance, network devices present in a software defined network may be divided into a number of plurality of groups, and each group may be called as a “cluster”. In such case, an exclusive optimizer may be assigned for each cluster of network devices. A software defined network, thus, may include a plurality of optimizers. For each cluster, an assigned optimizer may act as a mediator between a central SDN controller and a network device present in the cluster. In an instance, an assigned optimizer may intercept an unknown flow from a network device of the cluster to the SDN controller.

In the example of FIG. 1, system (or optimizer) 100 may include a flow transceiver module 102, a control communication module 104, an aggregator module 106, a packet caching module 108, and a flow entry distributor module 110. The term “module” may refer to a software component (machine readable instructions), a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. A module may reside on a volatile or non-volatile storage medium and configured to interact with a processor of a system (e.g. 100).

Flow transceiver module 102 may receive an unknown flow from a network device of a software defined network. In an instance, the unknown flow is meant for an SDN controller in the software defined network. In an example, flow transceiver module 102 may intercept an unknown flow to an SDN controller from a network device of a “cluster” in a software defined network. In an instance, flow transceiver module 102 may intercept unknown flows only from network devices of a particular cluster in a software defined network.

Controller communication module 104 may inform or advertise to an SDN controller a capability of the optimizer. In an example, the capability may include an aggregation capability of the optimizer (for instance, how many headers packets may be aggregated by an optimizer for sharing with an SDN controller, what size or portion of an unknown data packet may be used by an optimizer during an aggregation, etc.). In another example, the capability may include a buffering capability of the optimizer (for instance, how many original data packets from an unknown flow may be buffered by an optimizer). In another example, the capability may include metrics such as, but not limited to, the maximum load an optimizer may handle, current load handled by an optimizer. In a further example, controller communication module 104 may share details related to different profiles or modes in which an optimizer may operate, to an SDN controller. Controller communication module 104 may also provide packet priority information to an SDN controller in case a load threshold is exceeded. An SDN controller may generate and register a profile of an optimizer based on the information shared by controller communication module 104 of an optimizer. In an instance, depending on the information received from controller communication module 104 of an optimizer, an SDN controller may respond to the optimizer by providing the flow entry tuples that the SDN controller may be interested in receiving from the optimizer. Such information may help the optimizer to plan an aggregation or buffering criterion. For instance, if the controller is interested only in an IP subnet, the optimizer may send just the L3 header to the controller. In an instance, controller communication module 104 may receive various types of information from an SDN controller. Such information may relate to, by way of examples, the current load of an SDN controller and data packet prioritization information.

Aggregator module 106 may aggregate a portion of a data packet from each data packet in a plurality of data packets from an unknown flow, into a single package. In an instance, aggregate module 106 may select a “portion” of the data packet for aggregation based upon a predefined criterion between the optimizer and the controller. For example, if the agreement between the optimizer and the controller includes that the optimizer would share the first 40 bytes of a data packet from an unknown flow with the controller; aggregate module 106 may select such portion (i.e. the first 40 bytes from a data packet) accordingly. In an instance, the “portion” may include the header portion of a data packet from an unknown flow. In such case, aggregate module 106 may aggregate multiple packet headers into a single packet or request. Once a portion of a data packet from each data packet in a plurality of data packets from an unknown flow is aggregated into a single package, aggregate module 106 may send the package to an SDN controller. In an example, there may be a prioritization of the packets to be sent to the controller, depending on the load on the SDN controller. High latency traffic may be sent immediately, and low priority traffic may be deferred at the optimizer. In an example, in response to receiving the aggregated portion of the data packets from the unknown flow, the SDN controller may determine a flow path for the unknown flow in the software defined network.

Packet caching module 108 may cache or buffer packets from an unknown flow, which may be received by the optimizer 100 from a network device in a software defined network. In an instance, packet caching module 108 may buffer a plurality of data packets received from a network device that belongs to a cluster of network devices in a software defined network, based on an aggregation criteria. Packing caching module 108 may cache data packets from an unknown flow till the time an SDN controller informs the optimizer about the flow entries that are to be programmed on appropriate network devices for that flow. In other words, packet caching module 108 may not release buffered data packets into a software defined network until it determines that the SDN controller has decided a flow path for the unknown flow.

In an example, once an SDN controller determines a flow path for an unknown flow in a software defined network, in response to receiving the aggregated portion of data packets from the unknown flow, flow entry distributor module 110 may configure the flow path in appropriate network devices of the software defined network. The flow entries for the unknown flow may be communicated to the optimizer by the SDN controller. In an example, flow entry distributor module 110 may program the flow entries for an unknown flow on appropriate network devices of a cluster assigned to the optimizer 100.

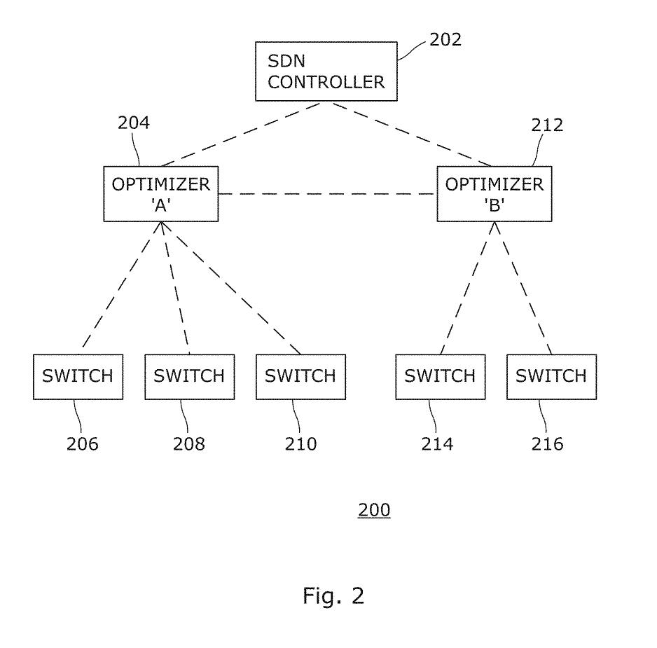

FIG. 2 is a diagram of an example network system 200 for controlling an unknown flow inflow to an SDN controller in a software defined network. Network system 100 may include an SDN controller 202, an optimizer “A” 204, an optimizer “B” 212, and a plurality of network switches 206, 208, 210, 214, and 216. Although only one SDN controller 202, two optimizers, and five switches are shown in FIG. 2, other examples of this disclosure may include more than one SDN controller, and more or less number of optimizers and network switches. In an example, network system 200 may include one or more computer systems or an end user device(s) (not shown) that may be the source or destination of packet flows into network system 200. In an example, network system 200 may be based on software-defined networking (SDN) architecture.

SDN controller 202 may be any server, computing device, or the like. In an example, SDN controller 202 may be a computer application (machine-executable instructions). SDN controller 202 may define the data flow that occurs in network system 200. In other words, SDN controller 202 may determine how packets should flow through the network devices 206, 208, 210, 214, and 216 of network system 200. SDN controller 202 may communicate with network devices 206, 208, 210, 214, and 216 via a standardized protocol (example, OpenFlow) or a suitable API.

SDN controller 202 may communicate with optimizers (204, 212) and switches 206, 208, 210, 214, and 216 over a computer network. Computer network may be a wireless or wired network. Computer network may include, for example, a Local Area Network (LAN), a Wireless Local Area Network (WAN), a Metropolitan Area Network (MAN), a Storage Area Network (SAN), a Campus Area Network (CAN), or the like. Further, computer network may be a public network (for example, the Internet) or a private network (for example, an intranet).

Switches 206, 208, 210, 214, and 216 may each include a physical network switch or a virtual switch. In an example, at least one of the network switches 206, 208, 210, 214, and 216 may be an SDN enabled device or an Open-Flow enabled device. Switches 206, 208, 210, 214, and 216 may each include one or more flow tables (not shown). Each flow table in switches 206, 208, 210, 214, and 216 may contain a flow entry (or flow entries) 206. SDN controller 202 may add, update, and delete flow entries in flow tables both reactively (in response to packets) and proactively. Switches 206, 208, 210, 214, and 216 may each communicate with SDN controller 202 via a standardized protocol such as OpenFlow. Switches 206, 208, 210, 214, and 216 may each accept directions from SDN controller 202 to change values in a flow table.

A flow table matches an incoming packet to a particular flow and specifies the function that may be performed on the packet. If a flow entry matching with a flow is found in a flow table, instructions associated with the specific flow entry may be executed. A packet matches a flow table entry if the values in the packet match fields used for the lookup match those defined in the flow table entry. If no match is found in a flow table (such cases may be termed as “flow table misses”), and the flow may be termed as an “unknown flow”. In such case, the packet may be forwarded to SDN controller 202. In an example, at least one of the switches 206, 208, and 210 may generate an unknown flow for the SDN controller 202 that may be intercepted by the optimizer “A” 204. Likewise, at least one of the switches 214 and 216 may generate an unknown flow for the SDN controller 202 that may be intercepted by the optimizer “B” 212.

In an example, switches 206, 208, 210, 214, and 216 present in network system 200 may be divided into a plurality of groups. Each group may be called as a “cluster”. In such case, an exclusive optimizer may be assigned for each cluster of switches. For each cluster, an assigned optimizer may act as a mediator between a SDN controller and a switch present in the cluster. In an instance, an assigned optimizer may intercept an unknown flow from a cluster switch to an SDN controller. Referring to FIG. 2, switches 206, 208, and 210, may be grouped together to form a cluster, and optimizer 204 “A” may be assigned to the cluster. In such case, optimizer “A” 204 may intercept an unknown flow for SDN controller 202 from one or more switches (206, 208, or 210) of the cluster. Likewise, switches 214 and 216 may be grouped together to form another cluster, and optimizer “B” 212 may be assigned to the cluster. In such case, optimizer “B” 212 may intercept an unknown flow for SDN controller 202 from one of the switches (214 and 216) of the cluster.

In an example, optimizers “A” 204 and “B” 212 may each be analogous to system 100, in which like reference numerals correspond to the same or similar, though perhaps not identical, components. For the sake of brevity, components or reference numerals of FIG. 2 having a same or similarly described function in FIG. 1 are not being described in detail in connection with FIG. 2. Said components or reference numerals may be considered alike. Optimizers “A” 204 and “B” 212 may each include a flow transceiver module, a control communication module, an aggregator module, a packet caching module, and a flow entry distributor module. In an example, aforementioned modules may perform functionalities similar to those described for flow transceiver module 102, control communication module 104, aggregator module 106, packet caching module 108, and flow entry distributor module 110 of FIG. 1, respectively. In an example, the flow transceiver module of optimizer 204 may intercept an unknown flow from switch 206 to SDN controller 202 in network system 200. The aggregate module may aggregate a portion of a data packet from each data packet in a plurality of data packets from the unknown flow, wherein the selection of the portion of the data packet may be based upon a predefined agreement with the SDN controller 202. The aggregate module may then send only the aggregated portions of the data packets to the SDN controller 202, in a single packet. The original data packets from the unknown data flow that are intercepted by the flow transceiver module may not be shared with the SDN controller 202. The packet caching module may buffer the plurality of data packets from the unknown flow. Once the SDN controller 202 receives the package containing the aggregated portions of the data packets, it may determine a flow path for the unknown flow, and communicate the flow path to the optimizer 204. Based on the received flow path, the flow entry distributor module may configure a flow entry for the flow path in an appropriate switch of the network system. In an example, the SDN controller 202 may configure a flow entry for the flow path in an appropriate switch of the network system 200.

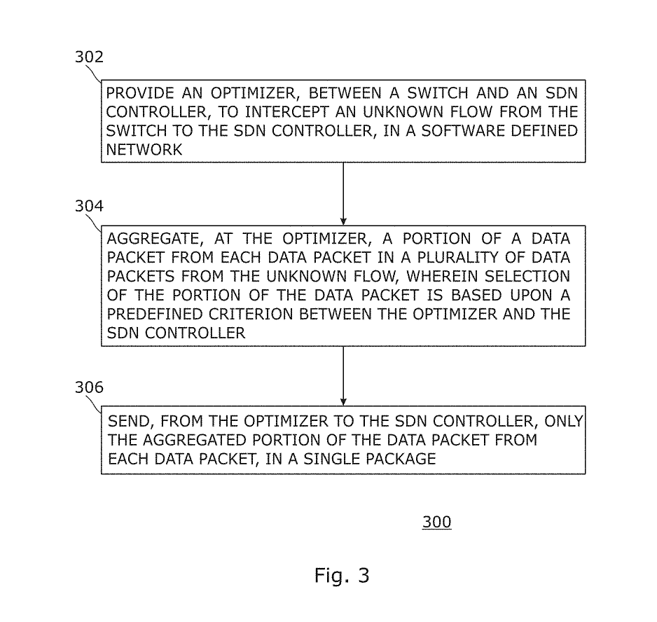

FIG. 3 is a block diagram of an example method 300 for controlling an unknown flow inflow to an SDN controller in a software defined network. The method 300, which is described below, may be executed on a computing device such as system of FIG. 1 or optimizers 214, 212 of FIG. 2. However, other suitable computing devices may execute method 300 as well. At block 302, an optimizer may be provided, between a switch and an SDN controller, to intercept an unknown flow from the switch to the SDN controller, in a software defined network. At block 304, a portion of a data packet from each data packet in a plurality of data packets from the unknown flow may be aggregated at the optimizer. In an example, selection of the portion of the data packet may be based upon a predefined criterion between the optimizer and the SDN controller. At block 306, only the aggregated portion of each data packet may be sent from the optimizer to the SDN controller, in a single package.

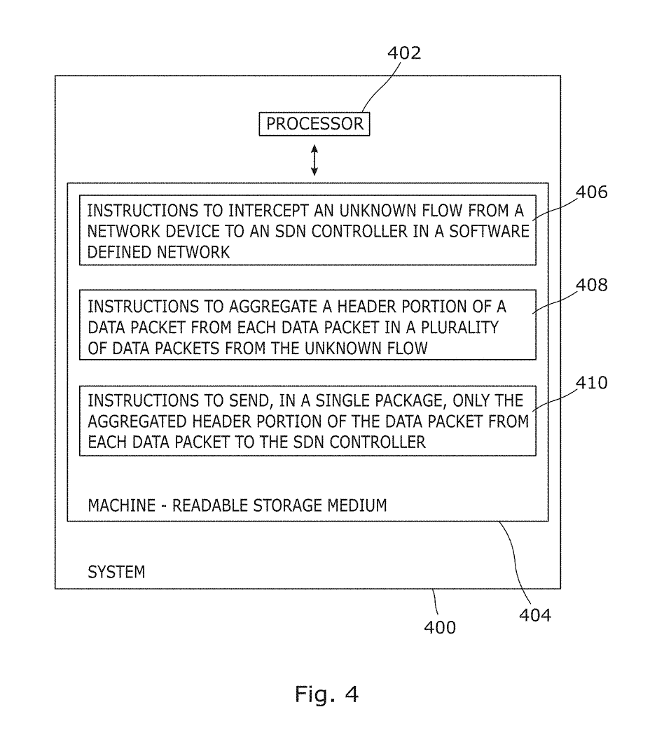

FIG. 4 is a block diagram of an example system 400 for controlling an unknown flow inflow to an SDN controller in a software defined network. System 400 includes a processor 402 and a machine-readable storage medium 404 communicatively coupled through a system bus. In an example, system 400 may be analogous to SDN controller 102 of FIG. 1. Processor 402 may be any type of Central Processing Unit (CPU), microprocessor, or processing logic that interprets and executes machine-readable instructions stored in machine-readable storage medium 404. Machine-readable storage medium 404 may be a random access memory (RAM) or another type of dynamic storage device that may store information and machine-readable instructions that may be executed by processor 402. For example, machine-readable storage medium 404 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, machine-readable storage medium may be a non-transitory machine-readable medium. Machine-readable storage medium 404 may store instructions 406, 408, and 410. In an example, instructions 406 may be executed by processor 402 to intercept an unknown flow from a network device to an SDN controller in a software defined network. Instructions 408 may be executed by processor 402 to aggregate a header portion of a data packet from each data packet in a plurality of data packets from the unknown flow. Instructions 410 may be executed by processor 402 to send, in a single package, only the aggregated header portion of the data packet to the SDN controller.

For the purpose of simplicity of explanation, the example method of FIG. 3 is shown as executing serially, however it is to be understood and appreciated that the present and other examples are not limited by the illustrated order. The example systems of FIGS. 1, 2 and 4, and method of FIG. 3 may be implemented in the form of a computer program product including computer-executable instructions, such as program code, which may be run on any suitable computing device in conjunction with a suitable operating system (for example, Microsoft Windows, Linux, UNIX, and the like). Embodiments within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be noted that the above-described examples of the present solution is for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

1. A method of controlling an unknown flow inflow to an SDN controller in a software defined network (SDN), comprising:
providing an optimizer, between a switch and an SDN controller, to intercept an unknown flow from the switch to the SDN controller, in a software defined network;
aggregating, at the optimizer, a portion of a data packet from each data packet in a plurality of data packets from the unknown flow, wherein selection of the portion of the data packet is based upon a predefined criterion between the optimizer and the SDN controller; and
sending, from the optimizer to the SDN controller, only the aggregated portion of the data packet from each data packet, in a single package.

2. The method of claim 1, further comprising buffering the plurality of data packets from the unknown flow at the optimizer.

3. The method of claim 2, further comprising releasing, by the optimizer, the buffered data packets into the software defined network, in response to determining by the optimizer that the SDN controller has decided a flow path for the unknown flow.

4. The method of claim 1, wherein a flow path for the unknown flow is determined by the SDN controller, in response to receiving the aggregated portion of each data packet.

5. The method of claim 4, wherein the flow path for the unknown flow is configured in a network device by the SDN controller.

6. A system to control an unknown flow inflow to an SDN controller in a software defined network (SDN), comprising:
a flow transceiver module to intercept an unknown flow from a switch to an SDN controller, in a software defined network; and
an aggregator module to:
aggregate a portion of a data packet from each data packet in a plurality of data packets from the unknown flow, wherein selection of the portion of the data packet is based upon a predefined agreement with the SDN controller; and
send, in a single packet, only the aggregated portion of the data packet from each data packet to the SDN controller.

7. The system of claim 6, further comprising a packet caching module to buffer the plurality of data packets from the unknown flow.

8. The system of claim 6, further comprising a flow entry distributor module to receive a flow path for the unknown flow from the SDN controller.

9. The system of claim 8, wherein the flow entry distributor module to configure a flow entry in a network device based on the received flow path.

10. The system of claim 6, wherein the portion includes a header portion of the data packet.

11. A non-transitory machine-readable storage medium comprising instructions to control an unknown flow inflow to an SDN controller in a software defined network, the instructions executable by a processor to:
intercept an unknown flow from a network device to an SDN controller in a software defined network;
aggregate a header portion of a data packet from each data packet in a plurality of data packets from the unknown flow; and
send, in a single package, only the aggregated header portion of the data packet from each data packet to the SDN controller.

12. The storage medium of claim 11, further comprising instructions to buffer the plurality of data packets from the unknown flow.

13. The storage medium of claim 11, further comprising instructions to release the buffered data packets into the software defined network in response to a determination that the SDN controller has decided a flow path for the unknown flow.

14. The storage medium of claim 11, further comprising instructions to receive, from the SDN controller, a flow path for the unknown flow in the software defined network.

15. The storage medium of claim 14, further comprising instructions to configure the flow path for the unknown flow in a network device of the software defined network.
